(19) United States
(12) Patent Application Publication
(10) Pub. No.: US 2003/0061605 A1
(43) Pub. Date: Mar. 27, 2003

(54) Remote e-purse payment system

(76) Inventors: Christophe Genevois, La Ciotat (FR); Wolfgang Neifer, Freising (DE); Michael Krall, Wolfersdorf (DE)

Correspondence Address: Finnegan Henderson Farabow Garrett & Dunner, 1300 I Street NW, Washington, DC, 20005, US

(21) Appl. No.: 09/936,303

(22) PCT Filed: Jan. 12, 2001
(86) PCT No.: PCT/EP01/00349

(30) Foreign Application Priority Data
Jan. 13, 2000 (DE) 100 01 097.0

(51) Int. Cl. H04N 7/16; H04K 1/00; H04L 9/00; G06F 17/60

(52) U.S. Cl. 725/6; 705/59

(57) ABSTRACT

A remote electronic purse payment system for use in a content provider/subscriber environment is provided. Prior to an entitlement of a subscriber to receive and/or unscramble a particular content, and at the subscriber's discretion, a corresponding amount is debited on an electronic purse card (16) and corresponding transaction data are temporarily stored in a protected local storage within a CAM module (14) associated with the subscriber. The stored transaction data are protected against unauthorized access and cannot be withheld from authorized collection by the content provider. Entitlement to receive and/or unscramble the particular content is enabled locally within the CAM module (14). Deferred financial transactions are performed on demand of the content provider and over a remote communication channel to collect transaction data stored in the protected local storage. As an alternative, prepaid value points are deducted from the electronic purse card (16) and stored in the protected storage for later collection by the provider.

The present invention relates to a remote electronic purse (e-purse) payment system for use in a content provider/subscriber environment such as a PPV (Pay-Per View), a VOD (Video On Demand) or a PPP (Pay Per Pulse) environment. Typically, such an environment will be incorporated in a cable or satellite based Pay-TV system or in a network such as the Internet.

In a typical cable or satellite based Pay-TV environment, a STB (Set-Top-Box) provides an interface between the broadcast channel and a TV set. The STB has a slot, referred to as a CI (Common Interface), for accommodation of a CAM (Conditional Access Module) unit embodied as a PCMCIA module which, in turn, incorporates a Smartcard reader for a subscriber card.

Payment of small amounts in such an environment, also referred to as micropayments, can be done with an e-purse card, inserted in the Smartcard reader of the CAM module instead of the subscriber card on request of an EPG (Electornic Program Guide) or a specific event stimulated by a broadcast Video/Audio data stream. The request for a micro-payment occurs prior to getting an entitlement for viewing a desired content, which will be unscrambled upon such payment.

Payments with an e-purse card on a STB are currently performed by setting up an interactive payment protocol within the STB. The CAM makes a request for reading the e-purse card an communicating with a remote backend server holding a merchant security card called P-SAM (Purchase Security Access Module). A secured financial transaction involves interaction of the e-purse card, through the CAM in the STB, with a remote merchant card and storing the resulting transaction in a transaction storage inside the server. Upon such payment, a pay-per-view can be unscrambled by the CAM.

In such a payment system, since payments must be made prior to getting an entitlement to view a specific content, there is a considerable risk of congestion in the communication process with the remote merchant server e.g. in a switched public telephone network in the event a large number of subscribers wanted to make transactions at the same time, as would typically happen with contents of a high degree of actuality, such as sports events. All of the transactions would have to be completed within a short period of time, normally just before a payable content would be broadcast. In addition to the risk of congestion, such a solution requires normally holding out resources for serving many communication lines as well as holding out many merchant server modules capable of performing fast transactions simultaneously.

The present invention provides a better performing and more flexible payment scheme. According to the invention, the time of payment is dissociated from the the content event.

Specifically, according to a first aspect of the invention, a remote electronic purse payment system for use in a content provider/subscriber environment is provided. Prior to an entitlement of a subscriber to receive and/or unscramble a particular content, and at the subscriber's discretion, a corresponding amount is debited on an electronic purse card and corresponding transaction data are temporarily stored in a protected local storage within a module associated with the subscriber. The stored transaction data are protected against unauthorized access and cannot be withheld from authorized collection by the content provider. Entitlement to receive and/or unscramble the particular content is enabled locally within the module associated with the subscriber. Deferred financial transactions are performed on demand of the content provider and over a remote communication channel to collect transaction data stored in the protected local storage.

According to a second aspect of the invention, a remote electronic purse payment system for use in a content provider/subscriber environment is provided wherein a prepaid amount corresponding to multiple value points is debited on an electronic purse card and stored in a protected local value register within a module associated with the subscriber. Entitlement to receive and/or unscramble the particular content is subjet to a deduction of corresponding value points from the value register locally within the module associated with the subscriber. Deferred financial transactions are performed on demand of the content provider and over a remote communication channel to collect deducted value points.

Other aspects of the invention are the following:

to install the P-SAM inside a conditional access module (instead of in a remote server)

to provide a method to locally secure transactions that they cannot be deleted/withheld for authorized collection (by fraudulent manipulations) by a service provider. The transmission of untransferred transactions would be initiated from the CAM.

to establish a value storage in secured storage area where an prepaid amount/value is stored for enabling several smaller consecutive transactions for pay per views without the further interaction of the e-purse card. The subscriber card remains in the module as long as prepaid value is available.

allowing services by separate transaction recording in order to cope with a plurality of service providers

to find a secure but open architecture to allow interaction of diverse conditional access systems with one or several e-purse systems or payment schemes.

option:

to provide a solution to provide URL (Universal Remote Locator) to Website and then make payment/transfer payment alternately.

Specific embodiments of the inventive system are based on the following architecture:

A standard filter/descrambler unit for filtering & descrambling standardized video/multimedia data-streams

A Smartcard reader device function

A merchant security module P-SAM (detachable)

A transaction total value limitation storage

A transaction storage

A function for generation of displayable messages for support of payment procedures/user information or interaction

Cryptographic coprocessing, verification of signatures (RSA algorithm)

Secured memory

for storing session keys

holding signatures assigned to transactions, a group of transactions

having a stored value register for view per pulse functions

providing transaction log (with time stamping, if time broadcasted)

secured compartments holding transactions for multiple service providers

A function to provide return path (modem) protocol support for remote communications with P-SAM, Smartcard and CAM functions

A timer/clock calender function.

In the inventive system, the following steps are typically performed for a one time session payment:

1) The broadcaster sends a specific EMM (entitlement management message for single subscriber addressing with condition of prepaying a specific amount at a certain time broadcast, (optional for this purpose sending time and date). Setting timing conditions in the CAM

2) CAM filters a secret key from the broadcast stream (being sent for a certain time),

2a) may also come from the Smartcard as a decrypted specific controlword or key,

2b) stores the amount payable in the ,,hidden” RAM space (secure storage, address space belongs to a specific provider)

2bb) filters a public-key for reading the certificate from the clearing house

2c) ask user to confirm a specific payment for a single pay-per-view session

3) Check for limit in the ,,limit transaction storage” (CAM)

3a) get a session key from P-SAM, authorizing the transaction,

3b) get key signed with private key from subscriber card

3c) store (session key) certificate in ,,secure storage”

3cc) store session key on Smartcard

4) Ask for e-purse card insertion and for confirmation

5) Cross-Check: Authentication of cards, P-SAM-e-purse, verification of signatures (standard)

5a) initiate order request to user and get user decision

5b) confirm by time stamping,

5c) CAM initiates P-SAM for transaction

6) Perform transaction and store it in the CAM transaction storage

6a) using controlword (derived from EMM)

6aa) and generate an offset/secret address (with the help of the session key generated by the P-SAM)

6b) generate time stamp (CAM) for session key from P-SAM, signing it with public key from Content Provider

7) Enter subscriber card and after authorization to allow the standard descrambling process for pay per view

7a) comparison of session key in Smartcard, token for validation of transaction (if positive) alternative:

7b) make a comparison on a following broadcast request (another EMM) filtered and use this as token for validation of transaction (if positive)

8) Descrambling of payload

(Start timer in CAM if pay per pulse)

9) Transfer of transactions,

9a) initiated (by call) from clearing service requesting for authentication, exchanging certificates

9aa) CAM verifies certificate from clearing house

9bb) sends the certificate from the Smartcard to the server, server returns the session key

9cc) CAM allows access to transaction storage by session key

9b) transfer of transactions

9c) transfer initiated by CAM (when reloading e-purse), calling the server for reload

10) Records (journal) of transfers performed, sets status in the ,,limit transaction storage”

11) User initiated value transfer into e-purse (load)

11a) sign session key and time with public key of content provider by Subscriber Smartcard

In an embodiment according to the second aspect of the invention a prepaid multiple session register is used. The basic payment is performed as defined above (1-7); however, the payment is stored as value points in the secured value register, from which value is deducted upon pay-per-view requirements. Value point transaction recording is done in a similar way. The transaction log is done under the same premises. Another function is the deduction of smallest units equivalent to small micro-payments (1 value point=1 cent) for pay per pulse from the value register.

A specific value point transaction may allow to reconvert value points into e-cash and being restored on the e-purse card.

Further features and advantages of the invention will become apparent from the following detailed description with reference to the drawings. In the drawings:

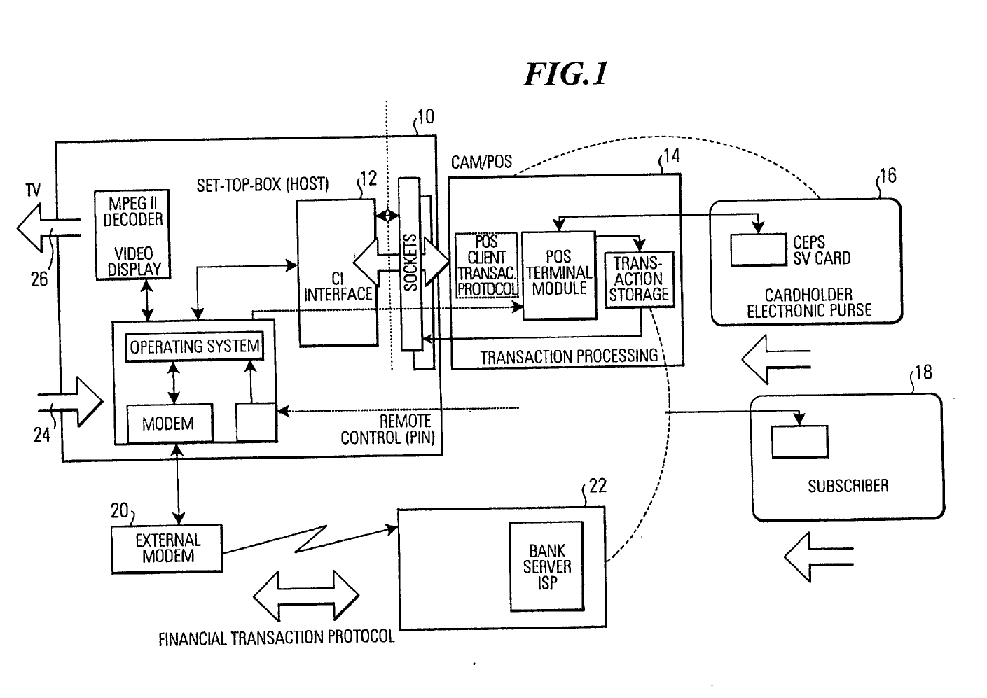

FIG. 1 is a schematic block diagram providing an overview of the inventive system;

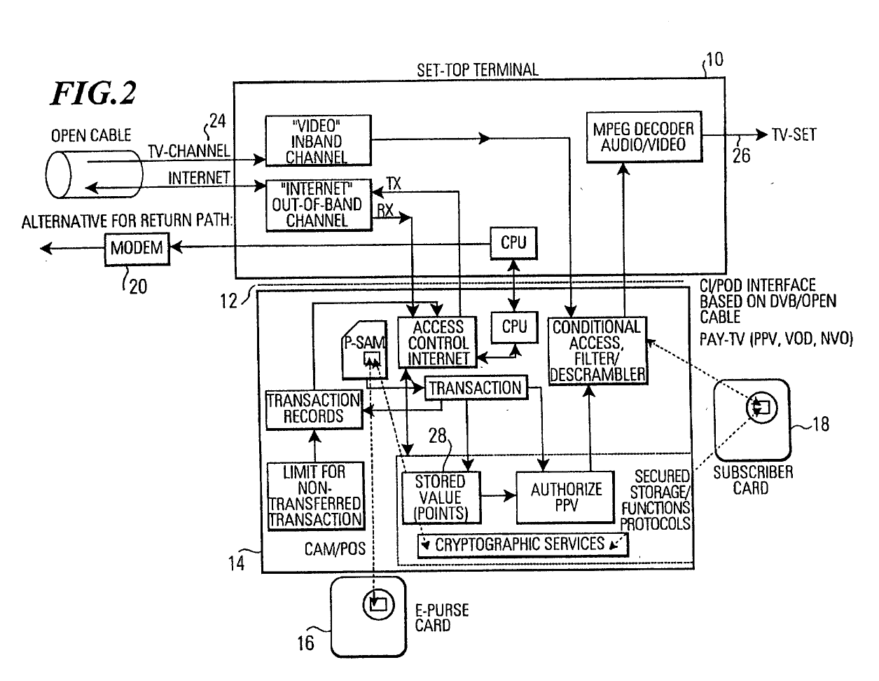

FIG. 2 is a block diagram showing a specific embodiment of the system;

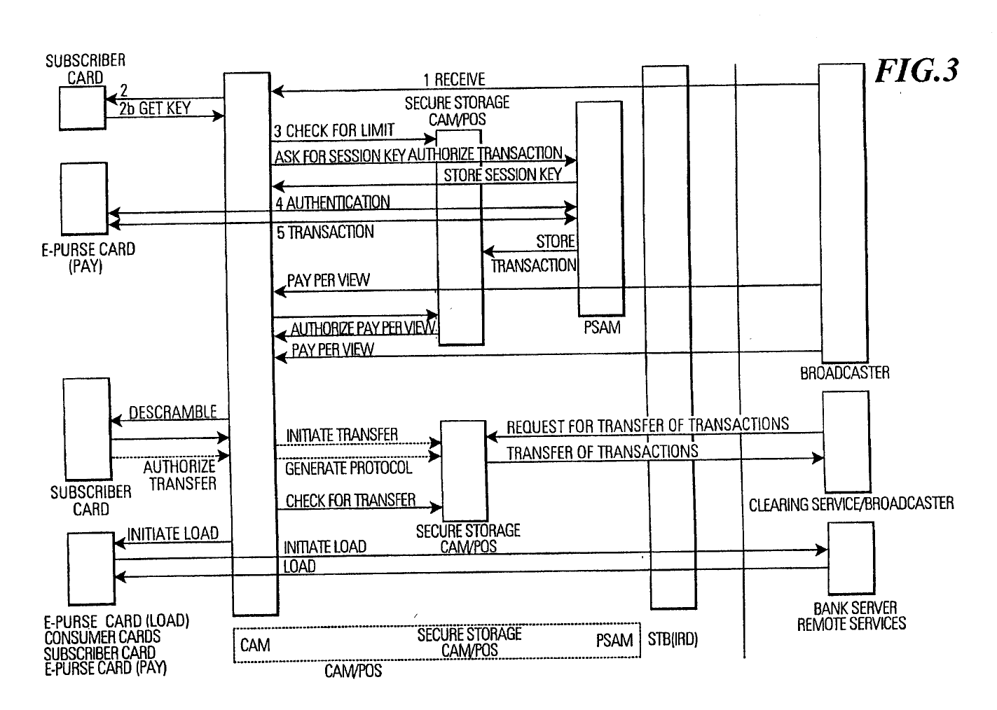

FIG. 3 is a chart illustrating various steps and actions performed in the system:

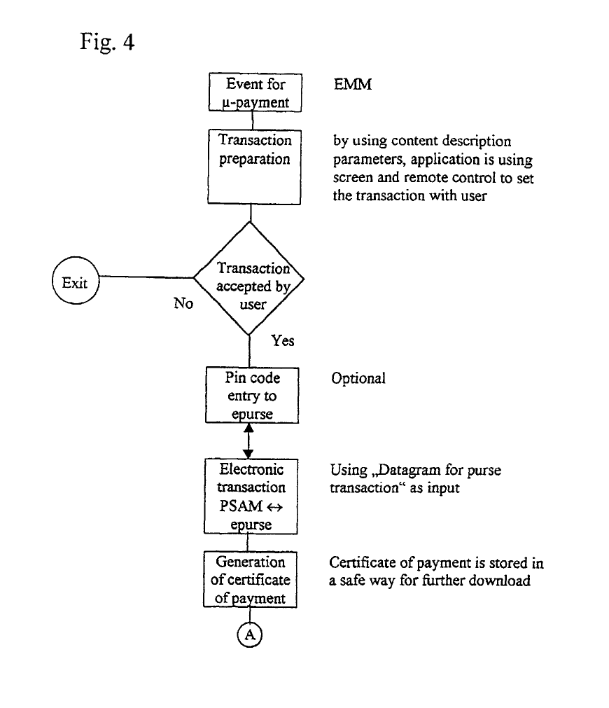

FIG. 4 is a flow chart illustrating the generation of a certificate of payment; and

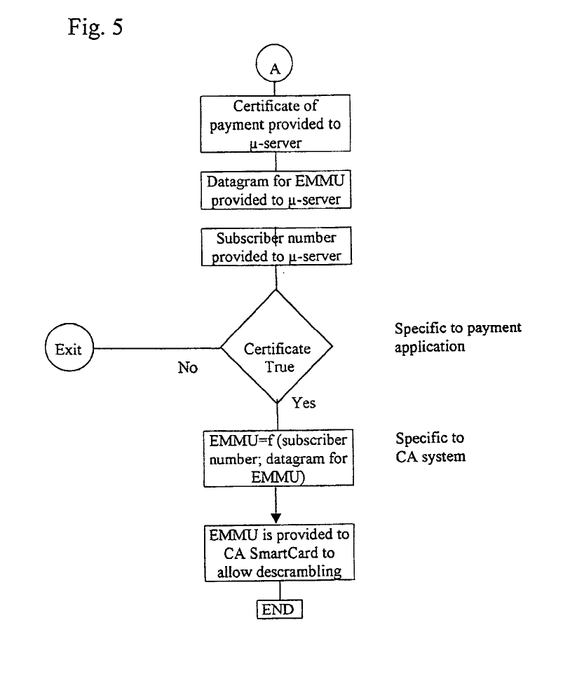

FIG. 5 is a flow chart illustrating the generation of an entitlement code based on the certificate of payment.

With reference to FIG. 1 of the drawings, the remote electronic purse payment system for use in a Pay-TV system includes, for each subscriber, a Set-Top-Box 10 with a common interface 12 embodied by a PCMCIA socket and a CAM module 14 embodied as a PCMCIA card for connection to the common interface 12. The CAM module 14 incorporates a Smartcard reader for a Smartcard 16 shown as an electronic purse card or a Smartcard 18 shown as a subscriber card. The Set-Top-Box 10 is connected to an external modem 20 for connection to at least one remote back-end bank server 22 via a conventional communcation link. The Set-Top-Box 10 has an input 24 for a TV-channel and an output 26 for a TV-set.

CAM 14 incorporates a software module for simulating functions of a merchant security card and a protected storage for storing transaction data.

In the alternative embodiment shown in FIG. 2, where like parts are identified with identical reference numerals, CAM 14 has a protected value register 28 for storing value points corresponding to an amount of money deducted from electronic purse card 16.

FIG. 3 illustrates the various steps carried out by the components of the system for a single session payment. Generally, the method performed in the inventive remote electronic purse payment system includes three successive operations:

a) in a first operation, a certificate of payment is generated;

b) in a second operation, a unique entitlement code is generated and provided to the CAM module for unscrambling of the data stream;

c) in a third deferred operation, transaction data are collected from the protected storage within the CAM module.

FIG. 4 illustrates the steps of the first operation. In step 100, an entitlement management message is received from the broadcaster, constituting an event for a micro payment. In step 102, parameters of a content description are used to prepare for a payment transaction. The subscriber can use information displayed on the TV screen an a remote control to set up the transaction. In step 104, the subscriber decides whether the transaction is accepted. If the transaction is accepted, a pin code is optionally entered in step 106. In step 108, the P-SAM embodied within CAM module 14 accesses the subscriber's electronic purse card 16 for deduction of an accepted amount. In step 110, a certificate of payment is generated and corresponding transaction data are stored within the protected storage in CAM module 14.

After the certificate of payment has been generated as a first operation, the method proceeds with the steps illustraded in FIG. 5 to generate a unique entitlement code as a second operation. With reference to FIG. 5, in step 112, the certificate of payment is provided to the simulated P-SAM within CAM module 14, the term “μ-server” being used to designate the simulated P-SAM. In step 114, a datagram for the unique entitlement code, designated as EMMU, is provided to the μ-server. In step 116, a subscriber number is provided to the server. In step 118, a check is made whether the payment certificate is true. This check is specific to the particular payment application. If true, the unique entitlement code EMMU is generated in step 120 as a function of the subscriber number and the datagram for EMMU. Finally, in step 122, the unique entitlement code EMMU is provided to CAM module 14 to allow unscrambling of the received data stream.

The above description has been made with reference to a Pay-TV system. However, the inventive system is applicable to any kind of remote payment using an electronic purse. In an application where a received data stream is stored as a file, the invention proposes a development in which a licence certificate is generated from the following data:

the datagram for the EMMU;

the certificate of payment;

the subscriber number;

the EMMU.

The licence certificate can be appended to the received data stream and stored in a file along with the data. The licence certificate can be used to detect an illegal copy.

1. A remote electronic purse payment system for use in a content provider/subscriber environment, wherein prior to an entitlement of a subscriber to receive and/or unscramble a particular content, and at the subscriber's discretion, a corresponding amount is debited on an electronic purse card and corresponding transaction data are temporarily stored in a protected local storage within a module associated with the subscriber, the stored transaction data being protected against unauthorized access, entitlement to receive and/or unscramble the particular content is enabled locally within the module associated with the subscriber, and deferred financial transactions are performed on demand of the content provider over a remote communication channel to collect transaction data stored in the protected local storage.

2. A remote electronic purse payment system for use in a content provider/subscriber environment, wherein a prepaid amount corresponding to multiple value points is debited on an electronic purse card and stored in a protected local value register within a module associated with the subscriber, entitlement to receive and/or unscramble the particular content is subjet to deduction of corresponding value points from the value register locally within the module associated with the subscriber, and deferred financial transactions are performed on demand of the content provider and over a remote communication channel to collect deducted value points.

3. The system of claim 1 or claim 2, wherein the module associated with the subscriber is a conditional access module and a merchant security module function is embodied within the conditional access module.

4. The system of claim 3, wherein the conditional access module is embodied as a PCMCIA form factor card.

5. The system of claim 3 or claim 4, wherein the conditional access module incorporates a smartcard reader.

6. The system of claim 1 or claim 2, wherein the module associated with a subscriber is used in an interface device connected between a user terminal and a broadcast channel.

7. The system of claim 2, wherein the subscriber card may remain in the module associated with the subscriber as long as prepaid value is available in the value register.

8. The system of claim 1 or claim 2, wherein a merchant security module function is simulated by a software module loaded into a conditional access module.

9. The system of claim 1 or claim 2, wherein a merchant security module function is simulated by a software module loaded into the subscriber card.

10. The system of claim 1 or claim 2, wherein a merchant security module function is simulated by a software module loaded into the electronic purse card.

11. The system of claim 1 or claim 2, wherein the protected storage comprises separate address spaces associated with and accessable by different content providers.

12. The system of claim 1 or claim 2, wherein a license certificate is generated from at least one of the following data:
a datagram derived form an entitlement management message received from the content provider;
a certificate of payment derived from the transaction data;
a subscriber number;
a unique code derived as a function of the datagram and the subscriber number.

13. The system of claim 12, wherein the particular content is locally stored in a file.

14. The system of claims 12 and 13, wherein the license certificate is appended to the particular content and stored in the file together with the content.
